(19) United States
(12) Patent Application Publication
(10) Pub. No.: US 2022/0144200 A1
(43) Pub. Date: May 12, 2022

(54) VEHICLE OCCUPANT PROTECTION SYSTEM

(71) Applicant: TOYODA GOSEI CO., LTD., Kiyosu-shi (JP)

(72) Inventors: Takumi TAOKA, Kiyosu-shi (JP); Soichiro NAGATSUNA, Kiyosu-shi (JP); Tomokazu SAKAI, Kiyosu-shi (JP); Tendo ISHIKAWA, Kiyosu-shi (JP); Kunihiro NOKURA, Kiyosu-shi (JP); Ryuji HASHIMOTO, Kiyosu-shi (JP)

(21) Appl. No.: 17/513,054

(22) Filed: Oct. 28, 2021

(30) Foreign Application Priority Data
Nov. 12, 2020 (JP) 2020-189005

(51) Int. Cl. B60R 21/015; G06K 9/00

(52) U.S. Cl. CPC B60R 21/01512; B60R 2021/01286; G06K 9/00375; G06K 9/00832

(57) ABSTRACT

Provided is technology that enables preventive processing to be performed at a proper timing as appropriate by detecting early that there is a danger about an occupant. A vehicle occupant protection system 1 includes: an imaging unit 20 configured to take an image of an occupant 90 who is in a vehicle 98, and an inside of a vehicle compartment 99, to acquire image information over time; and a control unit 30 configured to, during operation of the vehicle 98, analyze actions of the occupant 90 in time series on the basis of the image information, and when having determined that, among the actions of the occupant 90, a transfer preliminary action of the occupant 90 leading to place transfer has alone or cumulatively reached a predetermined danger level, perform preventive processing.

### CROSS REFERENCE TO RELATED APPLICATION

The present application claims the benefit of priority from Japanese Patent Application No. 2020-189005, filed on Nov. 12, 2020. The entire disclosure of the above application is incorporated herein by reference.

### TECHNICAL FIELD

The present invention relates to a vehicle occupant protection system.

### BACKGROUND

Conventionally, there have been known various types of vehicle occupant protection systems for protecting falling or the like of an occupant who is in a vehicle (see, for example, Japanese Laid-Open Patent Publication No. 2016-62414, hereafter referred as Patent Literature 1).

Patent Literature 1 shows a vehicle inside monitoring device mounted on a vehicle for transporting a passenger who is sitting or standing, the vehicle inside monitoring device including riding state recognition means for recognizing the riding state of the passenger, traveling state recognition means for recognizing the traveling state of the vehicle, and notification means for performing notification about safety of the passenger on the basis of the riding state and the traveling state.

Patent Literature 1 describes that the vehicle inside monitoring device recognizes the riding state of the passenger by the riding state recognition means, recognizes the traveling state of the vehicle by the traveling state recognition means, and performs notification about safety of the passenger by the notification means on the basis of the recognized riding state and traveling state, thus preventing falling of the passenger.

Here, Patent Literature 1 describes that the vehicle inside monitoring device performs preventive processing when there is a danger about the occupant. For example, Patent Literature 1 describes that, in such a case where the occupant is transferring in a vehicle compartment or the occupant is not sitting and not holding a strap or a handrail, the danger degree is determined to be high, and an alarm is issued to a driver in accordance with the traveling state of the vehicle.

However, as long as the occupant is transferring, the danger degree of the occupant is considered to be already high. Therefore, even if an alarm is issued at such a timing, a case where the driver is unable to cope with the alarm is also assumed, so that issuance of the alarm is too late.

Accordingly, in order to enhance reliability of occupant protection, there is demand of technology for enabling preventive processing to be performed at a proper timing as appropriate by detecting early that there is a danger about the occupant.

### SUMMARY

The present invention has been made in view of the above circumstances, and an object of the present invention is to provide technology for enabling preventive processing to be performed at a proper timing as appropriate by detecting early that there is a danger about the occupant.

In order to achieve the above object, a vehicle occupant protection system according to the present invention includes: an imaging unit configured to take an image of an occupant who is in a vehicle, and an inside of a vehicle compartment, to acquire image information over time; and a control unit configured to, during operation of the vehicle, analyze actions of the occupant in time series on the basis of the image information, and when having determined that, among the actions of the occupant, a transfer preliminary action of the occupant leading to place transfer has alone or cumulatively reached a predetermined danger level, perform preventive processing.

The vehicle occupant protection system according to the present invention enables preventive processing to be performed at a proper timing as appropriate by detecting early that there is a danger about the occupant.

### BRIEF DESCRIPTION OF DRAWINGS

FIG. 1 schematically illustrates a vehicle occupant protection system according to an embodiment;

FIG. 2 schematically illustrates a transfer preliminary action of an occupant detected by the vehicle occupant protection system according to the embodiment;

FIG. 3 illustrates operation of the vehicle occupant protection system according to the embodiment; and

FIG. 4 illustrates operation of the vehicle occupant protection system according to the embodiment.

### DETAILED DESCRIPTION

A vehicle occupant protection system according to the present invention includes an imaging unit and a control unit.

Of these, the imaging unit takes an image of an occupant who is in a vehicle, and the inside of a vehicle compartment, to acquire image information over time.

During operation of the vehicle, the control unit analyzes actions of the occupant in time series on the basis of the image information, and when having determined that, among the actions of the occupant, a transfer preliminary action of the occupant leading to place transfer has alone or cumulatively reached a predetermined danger level, the control unit performs preventive processing.

As used herein, the operation of the vehicle is a concept including both of a traveling state and a stopped state of the vehicle.

Among actions of the occupant in the vehicle compartment, in particular, place transfer has a high risk of leading to falling, and also in the above-described Patent Literature 1, a case where an occupant is performing place transfer is determined to be dangerous.

The vehicle occupant protection system of the present invention does not perform preventive processing on the basis of the fact that the occupant has performed place transfer, but performs preventive processing at a stage prior thereto, i.e., in accordance with the transfer preliminary action of the occupant leading to place transfer. The preventive processing includes issuing an alarm to a driver or the occupant and performing driving control of the vehicle.

In the vehicle occupant protection system of the present invention, before the occupant actually performs place transfer, the place transfer to be performed by the occupant is predicted and thus occurrence of a possibility of causing a danger to the occupant is detected. Therefore, the vehicle occupant protection system of the present invention enables the preventive processing such as an alarm to be performed at a proper timing as appropriate, thereby protecting the occupant.

The control unit in the vehicle occupant protection system of the present invention performs the preventive processing when having determined that the transfer preliminary action has alone or cumulatively reached the predetermined danger level. In other words, the control unit in the vehicle occupant protection system of the present invention not merely detects whether or not any transfer preliminary action has been performed but also determines whether the transfer preliminary action is slight or significant.

For example, in a case where only a transfer preliminary action that is slight or momentary and thus below the danger level is detected, the preventive processing may be avoided.

Alternatively, in this case, only milder processing (hereafter referred to as preceding processing) than the preventive processing may be performed. For example, in a case where an alarm by lighting up a red lamp is performed as the preventive processing, a yellow lamp may be lit up to call attention as the preceding processing.

The preceding processing may be performed independently of or in association with an intention action described later, but preferably, the preceding processing is performed in association with the intention action described later. For example, the preceding processing is preferably performed when the intention action is detected.

In a vehicle such as passenger transportation means in which there are a large number of occupants, if the preventive processing is performed for all transfer preliminary actions irrespective of whether each transfer preliminary action is slight or significant, there may be such a disadvantage that an alarm continues to be issued during traveling of the vehicle, for example. This may lead the driver to be careless or force the driver to be tense excessively.

In contrast, the vehicle occupant protection system of the present invention performs the preventive processing when having determined that the transfer preliminary action has reached the predetermined level, i.e., the danger level, thus enabling the preventive processing to be performed at a proper timing as appropriate, thereby protecting the occupant properly as appropriate.

In a case where the occupant starts to transfer, the danger degree increases. Therefore, preferably, the vehicle occupant protection system of the present invention continues the preventive processing while analyzing the action of the occupant, until the occupant's transfer is finished. Alternatively, after the occupant starts to transfer, the processing may be changed to heavier processing (hereafter referred to as advanced processing). For example, in a case where an alarm by lighting up a red lamp is performed as the preventive processing, an alarm by blinking the red lamp may be performed as the advanced processing. Similarly, also in such a case where the occupant suddenly starts to transfer without performing any transfer preliminary action, the advanced processing may be performed.

As used herein, the transfer is a concept including not only a walking action of the occupant but also an action of standing up or an action of sitting down.

Hereinafter, the vehicle occupant protection system of the present invention will be described for each component thereof.

The vehicle occupant protection system of the present invention may be for protecting the occupant in passenger transportation means or for protecting the occupant in a private automobile. That is, the vehicle referred to in the vehicle occupant protection system of the present invention is a concept including various types of vehicles such as a bus, a train, and a private vehicle.

The imaging unit in the vehicle occupant protection system of the present invention takes an image of the occupant who is in the vehicle, and the inside of the vehicle compartment, to acquire image information over time.

In addition to the above image information, the imaging unit may take an image of an item of the occupant and/or a vehicle interior part in the vehicle compartment, to acquire image information about these over time.

As used herein, the item of the occupant means an item carried by the occupant into the vehicle compartment, e.g., a bag, an outerwear, or a mobile terminal.

In many cases, the occupant is considered to transfer with the item. Therefore, image information about the item of the occupant is considered to be useful for detecting the transfer preliminary action of the occupant.

In the vehicle compartment, multiple vehicle interior parts such as seats and handrails are disposed. Combining image information about the inside of the vehicle compartment and image information about the occupant enables more accurate estimation for the following actions that may be taken by the occupant.

For example, in a case where the occupant near a handrail looks at the handrail or moves the hand, the occupant is estimated to be at a preceding stage for transferring to the handrail. In a case where the occupant looks at an empty seat, the occupant is estimated to be at a preceding stage for transferring to the empty seat. In a case where the occupant looks at the entrance/exit, the occupant is estimated to be at a preceding stage for transferring to the entrance/exit.

Further, acquiring the image information over time by the imaging unit enables the control unit described later to analyze the states of the occupant, the item thereof, and the inside of the vehicle compartment in time series, and thus to analyze the action of the occupant in time series. Accordingly, the control unit described later estimates whether the transfer preliminary action of the occupant is momentary or incidental, or the occupant has performed the transfer preliminary action at a preceding stage for transferring actually. As a result, accuracy for the control unit to determine whether or not the transfer preliminary action has reached the danger level is improved.

The image information taken by the imaging unit may be a still image or a moving image. In addition, the imaging manner, the format for storing data thereof, and the like are not particularly limited.

The imaging unit may be attached inside the vehicle compartment or outside the vehicle compartment, as long as the imaging unit is allowed to take an image of the occupant who is in the vehicle, and the inside of the vehicle compartment, and further, the item of the occupant and the vehicle interior part as necessary.

The imaging unit may take an image of all the occupants who are in the vehicle, the items of all these occupants, and the entirety of the inside of the vehicle compartment, or may only take an image of some of the occupants who are in the vehicle, and a part of the inside of the vehicle compartment. That is, the imaging unit may take an image of the occupant who is in the vehicle, and the inside of the vehicle compartment, only at a place where the occupant is likely to fall in the vehicle compartment.

Preferably, the imaging unit takes an image of the occupant who is in the vehicle, with an emphasis on the four limbs and the face thereof.

In a case where the imaging unit takes an image of the legs of the occupant, image information including change in the center of gravity of the occupant is obtained. Therefore, taking an image of the legs of the occupant by the imaging unit is useful for the control unit to immediately detect that the occupant starts to perform place transfer.

In a case where the imaging unit takes an image of the fingers of the occupant, image information including change of the occupant's action other than transfer, e.g., start or stop of operation on a mobile terminal or arrangement of items by the occupant, is obtained. Therefore, taking an image of the fingers of the occupant by the imaging unit is useful for detecting the intention action of the occupant described later.

In a case where the imaging unit takes an image of the face of the occupant, image information including change about the mouth and the eyes of the occupant, e.g., start or stop of talking by the occupant or movement of the eye direction of the occupant, is obtained. Therefore, taking an image of the face of the occupant by the imaging unit is useful for detecting the intention action of the occupant described later.

More preferably, the resolution of image information about the four limbs and the face of the occupant is high enough to recognize, in particular, any of movement of the eyes, movement of the mouth, and movement of the finger of the occupant, and even more preferably, the resolution is high enough to recognize all of these three kinds of movements.

Analyzing the action of the occupant on the basis of at least one of movement of the eyes, movement of the mouth, and movement of the finger of the occupant, enables detection for the intention action of the occupant described later.

Preferably, the imaging unit takes an image of at least one of the vicinity of a door, the vicinity of a seat directly behind the driver, and the vicinity of rear seats, regarding the inside of the vehicle compartment.

In particular, in a case where the vehicle is a bus, the vicinity of a door of the vehicle is considered to be an area having a high risk of falling of the occupant because there is often a step in the vicinity of the door.

In many buses, a seat directly behind the driver is positioned directly above the front wheel of the vehicle. The seat directly above the front wheel is often at a higher position than other seats, and thus is considered to be an area having a high risk of falling of the occupant.

Further, in a bus, there is a case where a door near the driver is an exit. In this case, during operation, in particular, even during traveling, the occupant may transfer to the vicinity of the exit, i.e., the vicinity of the seat directly behind the driver. Therefore, the vicinity of the seat directly behind the driver is considered to be an area having a high risk of falling of the occupant.

In a bus, in a case where a door near the driver is an exit, rear seats are far from the exit. In this case, an occupant sitting on a rear seat is expected to stand up from the rear seat in order to transfer to the exit before the vehicle stops. Therefore, the vicinity of the rear seats is also considered to be an area having a high risk of falling of the occupant.

The imaging unit may take an image of the inside of the vehicle compartment from any direction, but considering the purpose of taking an image of the occupant together with the inside of the vehicle compartment, taking the image from the lateral side is reasonable.

A period for which the imaging unit acquires the image information is not particularly limited, but preferably, the imaging unit acquires the image information continuously or intermittently during operation of the vehicle. In particular, the image information is preferably acquired continuously or intermittently during traveling of the vehicle. Further, the image information is preferably acquired also for a period just before start of traveling.

As another preferable example, areas where a load is possibly imposed on the occupant in the vehicle compartment, e.g., an area having many curves and an area having many intersections, may be specified in accordance with the traveling route of the vehicle registered in a car navigation system or the like, and the imaging unit may acquire the image information continuously when the vehicle travels in such areas.

Ina case where the danger degree of the occupant is estimated to be high on the basis of the transfer preliminary action of the occupant detected by the control unit described later, the detection sensibility of the imaging unit may be enhanced. For example, by increasing the frame rate (frames per second (fps)) at which the imaging unit takes an image, the detection sensibility of the imaging unit is enhanced.

Specifically, in a case where the control unit has detected a preparatory action or a last action described later as the transfer preliminary action, the danger degree of the occupant is estimated to be high. In addition, for example, in a case where the occupant is an elderly person or at an early age, in a case where the occupant is at a place where the danger degree is high such as a seat directly behind the driver's seat, in a case of traveling in an area having many curves or the like, and in a case of a bad weather, the danger degree of the occupant is estimated to be high.

The image information acquired by the imaging unit may be discarded after a given period has elapsed, or may be stored in a database.

The control unit analyzes the action of the occupant in time series on the basis of the image information acquired by the imaging unit. The control unit is electrically connected to the imaging unit via a wire or wirelessly so as to receive the image information from the imaging unit. A part or the entirety of the control unit is mounted on the vehicle. In a case where only a part of the control unit is mounted on the vehicle, the other part of the control unit may be mounted on a server provided outside. In a case where the entirety of the control unit is mounted on the vehicle, there is an advantage of increasing the processing speed of the overall system. On the other hand, in a case where a part of the control unit is mounted on the server provided outside, i.e., at a part other than the vehicle, for example, the analysis result of the control unit is shared among a plurality of vehicles, thus enabling vehicle control through cooperation between vehicles close to each other, e.g., speed reduction control. Such a control mechanism of the control unit may be applied to, for example, public transportation means such as fixed-route buses, shuttle buses operated in a specific area, or sightseeing buses operated such that a plurality of vehicles are arranged in series in the front-rear direction. This enables the vehicle occupant protection system of the present invention to be used more effectively in a centralized-management and centralized-control manner. Thus, a plurality of vehicles are operated more safely.

As the control unit, a computation device having a CPU, a memory, and the like may be used. The control unit may be a dedicated unit for the vehicle occupant protection system of the present invention, or may be a unit that also serves as an electronic control unit (ECU) of the vehicle.

The control unit detects, among the above occupant's actions, the transfer preliminary action of the occupant leading to place transfer of the occupant in the vehicle compartment, and when having determined that the transfer preliminary action has reached the predetermined danger level, the control unit performs the preventive processing. Hereafter, as necessary, the transfer preliminary action of the occupant may be simply referred to as a preliminary action.

The preliminary action is roughly classified into a preliminary action of a sitting occupant and a preliminary action of a standing occupant. In both cases, the preliminary action advances in three stages: initial stage, preparatory stage, and then last stage before transfer.

The initial stage means a stage where the occupant takes the intention action exhibiting an intention for performing place transfer before start of the transfer. The preparatory stage means a stage where the occupant takes the preparatory action for performing place transfer before start of the transfer. The last stage before transfer means a stage where the occupant takes the last action for performing place transfer before start of the transfer. Hereinafter, each stage will be described using an example in which the occupant is in the passenger transportation means.

First, in a case where the occupant is sitting, specific examples of the intention action at the initial stage include the following actions (1-a) to (1-h): (1-a) moving the eye direction to the vehicle advancing direction, (1-b) moving the eye direction to a vehicle window, (1-c) moving the eye direction to an indication device of the vehicle, (1-d) moving the eye direction to the own advancing direction, (1-e) moving the eye direction to the own feet, (1-f) stopping talking, (1-g) stopping usage of a mobile terminal, and (1-h) tidying up items.

In the passenger transportation means, in most cases, the sitting occupant performs place transfer when getting off the vehicle. Therefore, the above actions (1-a) to (1-h) are also considered to be actions exhibiting the occupant's intention to get off the vehicle.

Specifically, before getting off the vehicle, the occupant often takes the action (1-a), (1-b), or (1-c) to confirm whether or not the vehicle is close to the destination. Here, the indication device of the vehicle in (1-c) means an electronic sign, a display, or the like on which the destination of the vehicle, fares, the next station, and the like are displayed.

Before getting off the vehicle, the occupant often takes the action (1-d) or (1-f) to confirm whether or not a path to the door is ensured. Further, before getting off the vehicle, the occupant who has been talking with another occupant often stops talking (1-f), or the occupant who has been using a mobile terminal often stops usage of the mobile terminal (1-g). As used herein, the action of “stopping usage of the mobile terminal” includes an action of making the mobile terminal into a screen-locked state or a sleep state, an action of leaving the mobile terminal for a predetermined period after looking away from the screen thereof, or an action of putting away the mobile terminal into a bag, a pocket of an outerwear, or the like.

Before getting off the vehicle, the action (1-h) of tidying up items is often performed by putting an item such as a mobile terminal, a book, or a drink container into a bag which is also an item, or transferring an item placed, for example, on a rack or near the feet, to a hand area.

In a case where the occupant is sitting, specific examples of the preparatory action at the preparatory stage include the following actions (2-a) to (2-c): (2-a) putting the hand on the knee, (2-b) putting the hand on the seat, and (2-c) catching a handrail or a strap by the hand.

The above preparatory actions (2-a) to (2-c) are considered to be actions accompanied with a motion of the finger and/or the arm of the occupant.

The preparatory action is an action at a stage advanced from the above-described intention action, and is considered to be occupant's preparation for standing up from the seat in order to get off the vehicle.

The occupant who is sitting on the seat often increases the own support points as in the above actions (2-a) to (2-c), when standing up.

In a case where the occupant is sitting, specific examples of the last action at the last stage before transfer include the following actions (3-a) to (3-c): (3-a) raising the hip off the seat, (3-b) moving the back off the backrest of the seat, and (3-c) displacing the feet in the front-rear direction.

The above last actions (3-a) to (3-c) are considered to be actions accompanied with a motion of the lower limbs and/or the trunk of the occupant.

The occupant who is going to stand up from the seat in order to get off the vehicle often increases the support points as in the above actions (2-a) to (2-c) and then moves the center of gravity of the own body, as in the above actions (3-a) to (3-c).

On the other hand, in a case where the standing occupant performs place transfer, the following patterns are conceivable: a pattern in which the occupant transfers in a standing state, e.g., gets off the vehicle or transfers to a place where there are fewer other occupants, and a pattern in which the occupant shifts from a standing state to a sitting state, e.g., sits down on an empty seat.

In the pattern in which the occupant transfers in a standing state, specific examples of the intention action at the initial stage include the following actions (A-a) to (A-h): (A-a) moving the eye direction to the vehicle advancing direction, (A-b) moving the eye direction to a vehicle window, (A-c) moving the eye direction to the indication device of the vehicle, (A-d) moving the eye direction to the own advancing direction, (A-e) moving the eye direction to the own feet, (A-f) stopping talking, (A-g) stopping usage of a mobile terminal, and (A-h) tidying up items.

The actions (A-a) to (A-h) are considered to be actions exhibiting the occupant's intention to get off the vehicle, as in the above actions (1-a) to (1-h).

In the pattern in which the occupant transfers in a standing state, specific examples of the preparatory action at the preparatory stage include the following actions (B-a) and (B-b): (B-a) taking the hand off a handrail or a strap and (B-b) catching a handrail or a strap and then taking the hand off.

The action (B-a) is considered to be an action of the occupant decreasing the own support points, and the action (B-b) is considered to be an action for the occupant to obtain momentum for transferring.

In the pattern in which the occupant transfers in a standing state, specific examples of the last action at the last stage before transfer include the following action (C-a): (C-a) turning the direction of the body.

The action (C-a) is considered to be an action of the occupant moving the center of gravity of the own body, as in the above actions (3-a) to (3-c).

In the pattern in which the occupant shifts from a standing state to a sitting state, specific examples of the intention action at the initial stage include the following actions (I-a) and (I-b): (I-a) moving the eye direction to an empty seat and (I-b) looking around the passage.

The actions (I-a) and (I-b) are considered to be actions of the occupant confirming the own transfer destination.

In the pattern in which the occupant shifts from a standing state to a sitting state, specific examples of the preparatory action at the preparatory stage include the following actions (II-a) to (II-c): (II-a) catching a handrail or a strap by the hand, (II-b) putting the hand on the backrest of the seat, and (II-c) putting the hand on the armrest of the seat.

The actions (II-a) to (II-c) are considered to be actions of increasing the own support points, as in the above actions (2-a) to (2-c).

In the pattern in which the occupant shifts from a standing state to a sitting state, specific examples of the last action at the last stage before transfer include the following action (III-a): (III-a) turning the direction of the body.

The action (III-a) is considered to be an action of moving the center of gravity of the own body, as in the above actions (3-a) to (3-c).

When having detected each of various types of preliminary actions exemplified above, the control unit determines whether or not the detected preliminary action has reached the danger level.

One example of the procedure for the determination is as follows. In advance, the preliminary actions are imparted with danger scores that represent their danger degrees, and a cumulative value of the danger score at which the occupant is assumed to be exposed to a danger is defined as the danger level. Then, data of the danger scores and the danger level are stored in the control unit. Every time the control unit detects any preliminary action in the vehicle during operation, the control unit adds the danger score corresponding to the preliminary action, and compares the obtained cumulative value with the value of the danger level. Then, when the cumulative value has reached the danger level, the control unit performs the preventive processing.

Preferably, the danger scores are set so as to become higher as the stage of the preliminary action described above advances. That is, setting the danger scores of the preliminary actions so as to become higher in order of initial stage<preparatory stage<last stage before transfer is reasonable.

The danger score may be set to different values in accordance with the states of the occupant performing the preliminary action. For example, the danger score of the preliminary action at the initial stage performed by a standing occupant is preferably set to be higher than the danger score of the preliminary action at the initial stage performed by a sitting occupant. The reason is as follows. Since the standing occupant transfers more easily than the sitting occupant, a time taken until the occupant actually transfers from when the occupant performs the preliminary action is considered to be shorter in the case where the occupant is standing than in the case where the occupant is sitting.

The danger score may be set to different values in accordance with transition of the preliminary action. For example, in a case where, after the intention action of the occupant described above is detected, not the preparatory action but the last action is detected, the danger score may be set to a value different from a case where, after the intention action is detected, the preparatory action and then the last action are detected. However, the danger score is preferably set to be highest in the case where, after the intention action is detected, the preparatory action and then the last action are detected.

Abase score separate from the danger score of the preliminary action may be imparted in accordance with the state of the occupant performing the preliminary action. As a preferable example, a higher base score is imparted in a case where the occupant is standing than in a case where the occupant is sitting, and when the preliminary action is detected, the danger score is added to the base score.

Preferably, in a case where the standing occupant has completely sat on a seat, the cumulative danger score is once reset. The reason is as follows. When the occupant has sat, transfer of the occupant is considered to be once finished, and since the halfway state during changing of the occupant's posture, e.g., a half-crouching state is finished, the danger degree of the occupant is considered to be lowered. Also in a case where the sitting occupant has completely stood up, similarly, the cumulative danger score is preferably once reset.

When the danger score is reset, a base score may be newly imparted in accordance with the state of the occupant.

Further, also in a case where a next preliminary action is not detected even though a predetermined period has elapsed after detection of any preliminary action, the danger score may be reset. The predetermined period may be set on the basis of the elapsed time after detection of the preliminary action. The elapsed time may be, for example, 3 seconds to 15 seconds, or 5 seconds to 10 seconds.

Alternatively, the predetermined period may be set on the basis of the number of frames at which the imaging unit takes an image after detection of the preliminary action. For example, in a case where the imaging unit takes a still image at a frame rate of 20 (frames per second (fps)), the elapsed time may be, for example, 20 frames or more, or 60 frames or more.

When having determined that the transfer preliminary action has reached the predetermined danger level, the control unit performs the preventive processing. As described above, as the preventive processing, an alarm may be issued to the driver or the occupant, or driving control of the vehicle may be performed. Examples of the alarm include, besides lighting up a lamp and blinking a lamp, emitting a sound, displaying an image, and making vibration.

Examples of the driving control of the vehicle include reducing the speed and stopping the vehicle.

The vehicle occupant protection system of the present invention may include an alarm unit for issuing an alarm. In this case, examples of the alarm unit include a lighting device having a lamp, and a buzzer. Alternatively, an on-vehicle device such as a lighting device or an audio device may be used as the alarm unit, and operation of the alarm unit may be controlled by the control unit in the vehicle occupant protection system of the present invention.

Hereinafter, the vehicle occupant protection system of the present invention will be described using a specific example.

### Embodiment

A vehicle occupant protection system according to an embodiment is mounted on a vehicle of a bus which is one kind of passenger transportation means, so as to ensure safety of occupants who are in the vehicle.

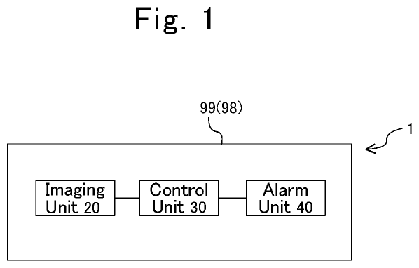

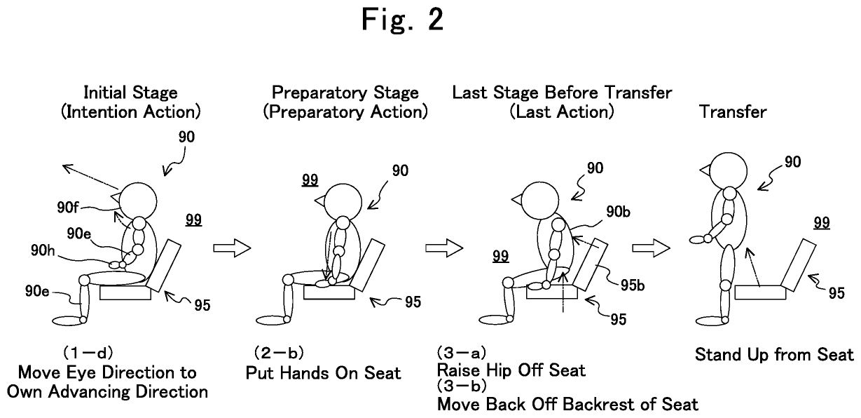

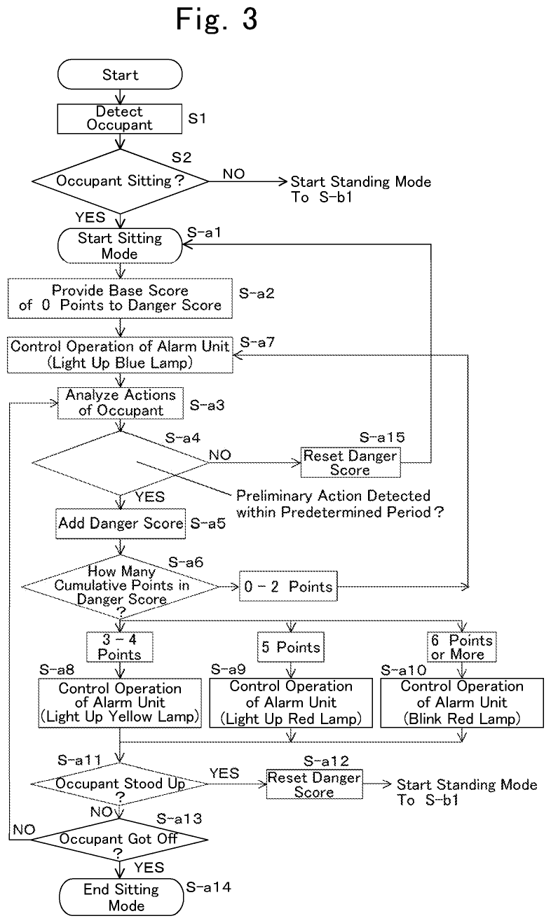

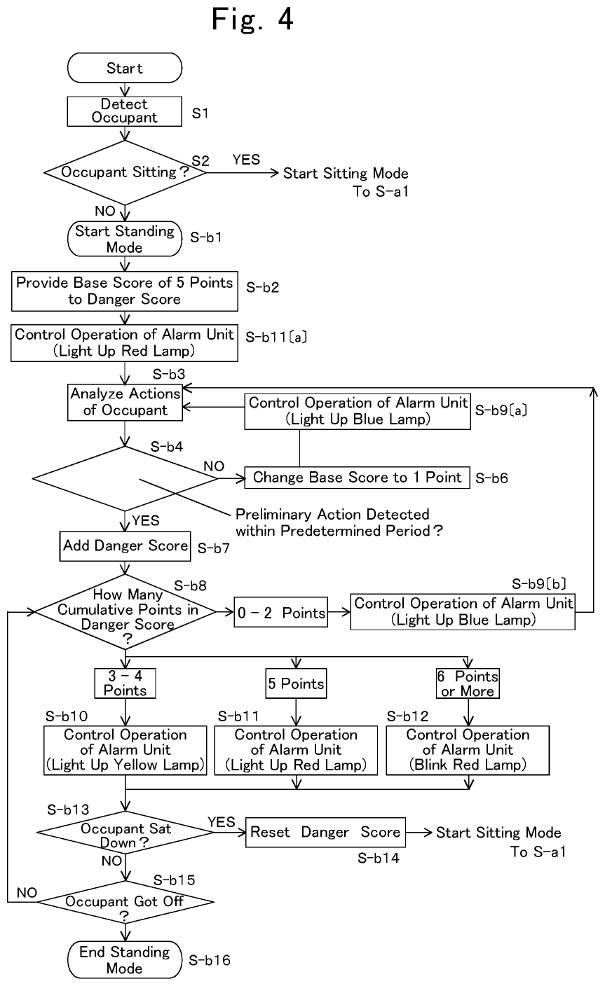

FIG. 1 schematically illustrates the vehicle occupant protection system according to the embodiment, and FIG. 2 schematically illustrates the transfer preliminary action of each occupant detected by the vehicle occupant protection system according to the embodiment. FIG. 3 and FIG. 4 illustrate operation of the vehicle occupant protection system according to the embodiment.

As shown in FIG. 1, a vehicle occupant protection system 1 according to the embodiment includes an imaging unit 20, a control unit 30, and an alarm unit 40. The imaging unit 20 includes cameras provided at a plurality of locations in a vehicle compartment 99, and takes a still image at a frame rate of 20 to 60 (frames per second (fps)).

More specifically, the imaging unit 20 is provided in the vicinity of a door, in the vicinity of a seat directly behind a driver, and in the vicinity of a rear seat (these are not shown), in the vehicle compartment 99 of a vehicle 98. At each location, the imaging unit 20 takes an image of an occupant 90 (see FIG. 2), an item (not shown) of the occupant 90, and a vehicle interior part (see FIG. 2) in the vehicle compartment 99. In particular, regarding the occupant 90, the imaging unit 20 takes an image of a face 90f (see FIG. 2) and four limbs 90e (see FIG. 2) thereof at high resolution.

The alarm unit 40 is a lighting device having a blue lamp, a yellow lamp, and a red lamp, and is provided in front of a driver's seat in the vehicle compartment 99.

The control unit 30 is electrically connected to the imaging unit 20 and the alarm unit 40 described above, and thus receives image information from the imaging unit 20 and performs operation control of the alarm unit 40.

Hereinafter, operation of the vehicle occupant protection system 1 according to the embodiment will be described.

First, with reference to FIG. 2, the preliminary action of the sitting occupant 90 will be described. Of the actions of the sitting occupant 90, an action before transfer, i.e., before a standing-up action, is the preliminary action. As shown in FIG. 2, in the embodiment, the preliminary action is assumed to advance in three stages: initial stage, preparatory stage, and then last stage before transfer.

The control unit 30 analyzes image information sent from the imaging unit 20, to detect the preliminary action of the occupant 90. The control unit 30 may determine and detect that the occupant 90 is performing the preliminary action, only if the occupant 90 is performing the preliminary action continuously during a plurality of frames. In this case, the preliminary action of the occupant 90 is less likely to be erroneously detected. Further, under the condition that the danger degree of the occupant 90 is high, the number of continuous frames described above may be decreased from 10 to 5, for example. This corresponds to decreasing the elapsed time after detection of the preliminary action from 0.5 seconds to 0.25 seconds, in a case where the frame rate is 20 fps. Thus, the preventive processing is performed so as to flexibly adapt to the danger degree that varies temporally and spatially.

If accuracy of detection for the preliminary action of the occupant 90 is sufficiently high, the control unit 30 may perform detection for the preliminary action with only one frame.

The initial stage is a stage where the occupant 90 takes the intention action. The control unit 30 in the embodiment analyzes the image information sent from the imaging unit 20, and detects, as the intention action, the following actions (1-a) to (1-h): (1-a) moving the eye direction to the vehicle advancing direction, (1-b) moving the eye direction to a vehicle window, (1-c) moving the eye direction to an indication device of the vehicle, (1-d) moving the eye direction to the own advancing direction, (1-e) moving the eye direction to the own feet, (1-f) stopping talking, (1-g) stopping usage of a mobile terminal, and (1-h) tidying up items.

For example, as shown in FIG. 2, in a case where the occupant 90 moves the eye direction from a hand area 90h to the upper side and looks ahead in the own advancing direction, the control unit 30 detects the intention action (1-d). The danger score of the intention action is 1 point. As described later, the danger score is accumulated and used for determining whether or not the preliminary action of the occupant has reached the danger level.

The preparatory stage is a stage where the occupant 90 takes the preparatory action. The control unit 30 in the embodiment analyzes the image information sent from the imaging unit 20, and detects, as the preparatory action, the following actions (2-a) to (2-c): (2-a) putting the hand on the knee, (2-b) putting the hand on the seat, and (2-c) catching a handrail or a strap by the hand.

For example, as shown in FIG. 2, in a case where the occupant 90 puts the hand on a seat 95, the control unit 30 detects the preparatory action (2-b). The danger score of this preparatory action is 2 points.

The last stage before transfer is a stage where the occupant 90 takes the last action. The control unit 30 in the embodiment analyzes the image information sent from the imaging unit 20, and detects, as the last action, the following actions (3-a) to (3-c): (3-a) raising the hip off the seat, (3-b) moving the back off the backrest of the seat, and (3-c) displacing the feet in the front-rear direction.

For example, as shown in FIG. 2, in a case where the occupant 90 raises the hip off the seat 95 and moves a back 90b off a backrest 95b of the seat 95, the control unit 30 detects the last action (3-a) and the last action (3-b). Each of the danger scores of these last actions is 3 points, and at this time, a total of 6 points are added to the cumulative value of the preliminary action.

Although not shown, the control unit 30 in the vehicle occupant protection system 1 according to the embodiment detects, as the preliminary action of the standing occupant 90, each of the actions (A-a) to (A-h), (B-a), (B-b), (C-a), (I-a), (I-b), (II-a) to (II-c), and (III-a) described above. Each of the danger scores of the preliminary actions (A-a) to (A-h) and the preliminary actions (I-a) and (I-b) is 1 point, each of the danger scores of the preliminary actions (B-a) and (B-b) and the preliminary actions (II-a) to (II-c) is 2 points, and each of the danger scores of the preliminary action (C-a) and the preliminary action (III-a) is 3 points.

In the vehicle occupant protection system 1 according to the embodiment, the control unit 30 detects the above preliminary action and accumulates the danger score, thereby determining whether or not the preliminary action of the occupant has reached the danger level. Then, when having determined that the preliminary action has reached the predetermined danger level, the control unit 30 performs the preventive processing, i.e., causes the alarm unit 40 to light up the lamp.

Hereinafter, with reference to FIG. 3 and FIG. 4, operation of the vehicle occupant protection system according to the embodiment will be described.

When the vehicle 98 is started up and starts operation, the vehicle occupant protection system 1 according to the embodiment is started. At this time, the imaging unit 20 starts to take an image at a frame rate of 20 fps, and sequentially sends image information to the control unit 30. The control unit 30 analyzes the image information to determine whether or not any occupant 90 is included in the image information. If the occupant 90 is detected (S1), the control unit 30 determines whether or not the occupant 90 is sitting (S2). If the occupant 90 is not sitting (NO in S2), the control unit 30 proceeds to start a standing mode (S-b1) described later.

If the occupant 90 is sitting (YES in S2), the control unit 30 starts a sitting mode (S-a1). At this time, the control unit 30 provides a base score of 0 points to the danger score (S-a2). Along with this, the control unit 30 performs control to light up the blue lamp of the alarm unit 40 for indicating safety (S-a7), and proceeds to S-a3 described later. In the vehicle occupant protection system 1 according to the embodiment, the danger level is set at 5 points.

Next, the control unit 30 analyzes actions of the occupant 90 on the basis of image information (S-a3), to detect the preliminary action of the occupant 90 (S-a4). If any of the preliminary actions described above has not been detected within a predetermined period (NO in S-a4), the control unit 30 resets the danger score (S-a15) and then returns to start the sitting mode (S-a1), to continue detection for the preliminary action.

If any of the preliminary actions described above has been detected (YES in S-a4), the control unit 30 adds the danger score corresponding to the preliminary action (S-a5) and calculates the cumulative value of the danger score (S-a6).

If the cumulative value is 0 to 2 points, the control unit 30 performs control to light up the blue lamp of the alarm unit 40 for indicating safety (S-a7), and proceeds to S-a3, to continue detection for the preliminary action.

If the cumulative value is 3 to 4 points, the control unit 30 lights up the yellow lamp of the alarm unit 40 for calling attention as the preceding processing (S-a8), and then proceeds to S-a11 described later.

If the cumulative value is 5 points, the control unit 30 performs control to light up the red lamp of the alarm unit 40 as the preventive processing (S-a9), and then proceeds to S-a11 described later.

Further, if the cumulative value is 6 points or more, the control unit 30 blinks the red lamp of the alarm unit 40 as the advanced processing (S-a10), and then similarly proceeds to S-a11 described below.

Subsequently, the control unit 30 detects whether or not the occupant 90 has stood up on the basis of the image information (S-a11). If the occupant 90 has stood up (YES in S-a11), the control unit 30 resets the danger score (S-a12) and proceeds to start the standing mode (S-b1) described later.

If the occupant 90 has not stood up (NO in S-a11), the control unit 30 determines whether or not the occupant 90 has gotten off on the basis of the image information (S-a13). As used herein, getting off includes a case where the occupant 90 transfers to the outside of the imaging range of the imaging unit 20. If the occupant 90 has gotten off (YES in S-a13), the control unit 30 ends the sitting mode (S-a14). If the occupant 90 has not gotten off (NO in S-a13), the control unit 30 returns to S-a3, to continue detection for the preliminary action.

On the other hand, if the occupant 90 has stood up (NO in S2), the control unit 30 starts the standing mode shown in FIG. 4 (S-b1). At this time, the control unit 30 provides a base score of 5 points to the danger score (S-b2). Along with this, the control unit 30 performs control to light up the red lamp of the alarm unit 40 as the preventive processing (S-b11 [a]), and proceeds to S-b3 described later. The red lamp lit up here in the preventive processing is turned off before the next lamp-light-up timing in S-b9 or the like described later, so as to be ready for switching to the next lighting up of the lamp.

The control unit 30 analyzes actions of the occupant 90 on the basis of the image information (S-b3), to detect the preliminary action of the occupant 90 (S-b4). If any of the above preliminary actions has not been detected within a predetermined period (NO in S-b4), the control unit 30 determines that the occupant is standing stably, and therefore changes the base score of the danger score to 1 point (S-b6). Along with this, the control unit 30 performs control to light up the blue lamp of the alarm unit 40 for indicating safety (S-b9 [a]), and returns to S-b3, to continue detection for the preliminary action.

If any of the above preliminary actions has been detected (YES in S-b4), the control unit 30 adds the danger score corresponding to the preliminary action (S-b7), and calculates the cumulative value thereof (S-b8[b]).

If the cumulative value is 0 to 2 points, the control unit 30 performs control to light up the blue lamp of the alarm unit 40 for indicating safety (S-b9[b]), and returns to S-b3.

If the cumulative value is 3 to 4 points, the control unit 30 lights up the yellow lamp of the alarm unit 40 as the preceding processing (S-b10), and then proceeds to S-b13 described later.

If the cumulative value is 5 points, the control unit 30 performs control to light up the red lamp of the alarm unit 40 as the preventive processing (S-b11), and proceeds to S-b13 described later.

Further, if the cumulative value is 6 points or more, the control unit 30 blinks the red lamp of the alarm unit 40 as the advanced processing (S-b12), and similarly proceeds to S-b13 described below.

Subsequently, the control unit 30 detects whether or not the occupant 90 has sat down on the basis of the image information (S-b13). If the occupant 90 has sat down (YES in S-b13), the control unit 30 resets the danger score (S-b14), and proceeds to start the sitting mode (S-a1).

If the occupant 90 has not sat down (NO in S-b13), the control unit 30 determines whether or not the occupant 90 has gotten off on the basis of the image information (S-b15). If the occupant 90 has gotten off (YES in S-b15), the control unit 30 ends the standing mode (S-b16). If the occupant 90 has not gotten off (NO in S-b15), the control unit 30 returns to S-b3, to continue detection for the preliminary action.

The vehicle occupant protection system according to the embodiment enables the preventive processing to be performed at a proper timing as appropriate by detecting early that there is a danger about the occupant.

The present invention is not limited to only the embodiment described above and shown in the drawings, but may be modified as appropriate without deviating from the scope of the present invention. In addition, the components shown in the description including the embodiment may be optionally taken out and combined with each other to carry out the present invention.

1. A vehicle occupant protection system comprising:
an imaging unit configured to take an image of an occupant who is in a vehicle, and an inside of a vehicle compartment, to acquire image information over time; and
a control unit configured to, during operation of the vehicle, analyze actions of the occupant in time series on the basis of the image information, and when having determined that, among the actions of the occupant, a transfer preliminary action of the occupant leading to place transfer has alone or cumulatively reached a predetermined danger level, perform preventive processing.

2. The vehicle occupant protection system according to claim 1, wherein
the image information further includes information about an item of the occupant or information about a vehicle interior part provided in the vehicle compartment.

3. The vehicle occupant protection system according to claim 1, wherein
the image information includes information about movement of an eye direction of the occupant.

4. The vehicle occupant protection system according to claim 1, wherein
the image information includes information about an action of a lower body of the occupant.

5. The vehicle occupant protection system according to claim 1, wherein
the transfer preliminary action includes an intention action of the occupant exhibiting an intention of the occupant to perform the place transfer.

6. The vehicle occupant protection system according to claim 1, wherein
the transfer preliminary action includes a preparatory action for the occupant to perform the place transfer before start of the place transfer, and
the preparatory action is an action accompanied with a motion of a finger and/or an arm of the occupant.

7. The vehicle occupant protection system according to claim 1, wherein
the transfer preliminary action includes a last action for the occupant to perform the place transfer before start of the place transfer, and
the last action is an action accompanied with a motion of a lower limb and/or a trunk of the occupant.

8. The vehicle occupant protection system according to claim 1, wherein
the control unit performs preceding processing milder than the preventive processing, before the transfer preliminary action has alone or cumulatively reached the danger level.

9. The vehicle occupant protection system according to claim 1, wherein
the vehicle is passenger transportation means.
